(19) United States
(12) Patent Application Publication
(10) Pub. No.: US 2023/0199262 A1
(43) Pub. Date: Jun. 22, 2023

(54) INFORMATION DISPLAY METHOD AND DEVICE, AND TERMINAL AND STORAGE MEDIUM

(71) Applicant: BEIJING BYTEDANCE NETWORK TECHNOLOGY CO., LTD., Beijing (CN)

(72) Inventors: Chi FANG, Beijing (CN); Haizhou ZHU, Beijing (CN); Xiao WANG, Beijing (CN); Keng XIE, Beijing (CN)

(21) Appl. No.: 18/008,288

(22) PCT Filed: Jun. 4, 2021
(86) PCT No.: PCT/CN2021/098465

§ 371 Date: Dec. 5, 2022

(30) Foreign Application Priority Data
Jun. 5, 2020 (CN) 202010507212.4

(51) Int. Cl. H04N 21/485; H04N 21/422; G06F 3/01

(52) U.S. Cl. CPC H04N 21/4858; G06F 3/017; H04N 21/42222

(57) ABSTRACT

The disclosure relates to the technical field of computers, in particular to an information display method and device, and terminal and storage medium. The information display method provided according to an embodiment of the disclosure includes: arranging two or more application user interfaces based on respective initial locations of the two or more application user interfaces, wherein at least one of the initial locations is located outside a screen display area of a display terminal; and adjusting, in response to a first operation by a user, sizes and locations of the two or more application user interfaces so as to adjust application display contents entering the screen display area of the display terminal. The information display method provided according to the embodiment of the disclosure enables a user to conveniently select the application user interfaces and improves the interaction efficiency.

### CROSS REFERENCE TO RELATED APPLICATIONS

The disclosure claims priority to Chinese Patent Application No. 202010507212.4, field on Jun. 05, 2020, titled “INFORMATION DISPLAY METHOD AND DEVICE, AND TERMINAL AND STORAGE MEDIUM”, the entire contents of which are incorporated herein by reference.

### FIELD

The disclosure relates to the technical field of computers, in particular to an information display method and device, and terminal and storage medium.

### BACKGROUND

Smart TVs have replaced traditional TVs and can be equipped with a wide range of programmes and applications for users to choose from and watch. When a smart TV is playing a programme or application, if a user wants to switch watch other programmes or applications, he or she needs to operate the remote control to exit the currently playing programme or application and return to a menu before they can choose to select other programmes or applications, which is a very cumbersome operation process with low interaction efficiency.

### SUMMARY

This summary part is provided to introduce concepts in a brief form, and these concepts will be further described in the following specific embodiments. The summary is intended to neither identify key features or essential features of the claimed technical solutions nor limit the scope of the claimed technical solutions.

One aspect of the disclosure provides an information display method, comprising:
arranging two or more application user interfaces based on respective initial locations of the two or more application user interfaces, wherein at least one of the initial locations is located outside a screen display area of a display terminal; and
adjusting, in response to a first operation by a user, sizes and locations of the two or more application user interfaces so as to adjust application display contents entering the screen display area of the display terminal.

Yet another aspect of the disclosure provides an information display device, comprising:
an arrangement unit, configured to arrange two or more application user interfaces based on respective initial locations of the two or more application user interfaces, wherein at least one of the initial locations is located outside a screen display area of a display terminal; and
an adjusting unit, configured to adjust, in response to a first operation by a user, sizes and locations of the two or more application user interfaces so as to adjust application display contents entering the screen display area of the display terminal.

Yet another aspect of the disclosure provides a terminal, comprising:
at least one processor; and
at least one memory communicatively coupled to the at least one processor and storing instructions that upon execution by the at least one processor cause the terminal to perform the information display method.

Yet another aspect of the disclosure provides a computer-readable storage medium, storing program codes that upon execution by a computing device, cause the computing device to perform the information display method.

According to an information display method provided in one or more embodiments of the disclosure, by arranging each application user interface based on the initial locations and adjusting the location of each application user interface in response to the first operation to adjust the application display contents in the screen display area of the display terminal, a user can conveniently and quickly select the application user interface on a screen, such as selecting a target application user interface not originally displayed on the screen, or adjusting sizes and locations of the application user interfaces to facilitate the selection of the target application user interface, thereby improving interaction efficiency and interaction experience.

### BRIEF DESCRIPTION OF THE DRAWINGS

The foregoing and other features, advantages and aspects of embodiments of the disclosure will become more apparent in combination with the accompanying drawings and with reference to the following specific embodiments. Throughout the accompanying drawings, the same or similar reference numerals indicate the same or similar elements. It should be understood that the accompanying drawings are schematic and that the components and elements are not necessarily drawn to scale.

FIG. 1 shows a flow diagram of an information display method provided according to an embodiment of the disclosure.

FIG. 2 shows a schematic diagram of initial locations of application user interfaces provided according to an embodiment of the disclosure.

FIG. 3 shows a schematic diagram of initial locations of application user interfaces provided according to another embodiment of the disclosure.

FIG. 4 shows a schematic diagram of initial locations of application user interfaces provided according to another embodiment of the disclosure.

FIG. 5 shows a schematic diagram of arrangement of application user interfaces in response to a first operation provided according to an embodiment of the disclosure.

FIG. 6 shows a schematic diagram of arrangement of application user interfaces in response to a first operation provided according to another embodiment of the disclosure.

FIG. 7 shows a schematic diagram of movement of application user interfaces provided according to an embodiment of the disclosure.

FIG. 8 shows a schematic structural diagram of an information display device provided according to one or a plurality of embodiments of the disclosure.

FIG. 9 is a schematic structural diagram of a terminal device configured to implement an embodiment of the disclosure.

### DETAILED DESCRIPTION OF THE DISCLOSURE

The embodiments of the disclosure will be described in more detail below with reference to the accompanying drawings. Although some embodiments of the disclosure are shown in the accompanying drawings, it should be understood that the disclosure may be implemented in various forms and should not be construed as being limited to the embodiments described herein, on the contrary, these embodiments are provided for a more thorough and complete understanding of the disclosure. It should be understood that the accompanying drawings and embodiments of the disclosure are merely illustrative, rather than limiting the scope of protection of the disclosure.

It should be understood that the steps described in the embodiments of the disclosure may be performed according to different orders and/or in parallel. In addition, the embodiments may include additional steps and/or omit the execution of the shown steps. The scope of the disclosure is not limited in this aspect.

The term “comprising” used herein and variants thereof means open-ended including, i.e., “including, but not limited to”. The term “based on” refers to “based at least in part on”. The term “one embodiment” represents “at least one embodiment”; the term “the other embodiment” represents “at least one additional embodiment”; and the term “some embodiments” represents “at least some embodiments”. Definitions of other terms will be provided in the description below.

It should be noted that the terms such as “first”, “second” and the like mentioned in the disclosure are merely intended to distinguish different devices, modules or units, rather than limiting an order of functions executed by these devices, modules or units or an interdependence among these devices, modules or units.

It should be noted that the modifications of “a” and “multiple” mentioned in the disclosure are illustrative, but are not restrictive. It should be understood by those skilled in the art that it should be understood as “one or more” unless otherwise specified in the context.

Names of messages or information interacted among a plurality of devices in the embodiments of the disclosure are merely for an illustrative purpose, rather than limiting the scope of these messages or information.

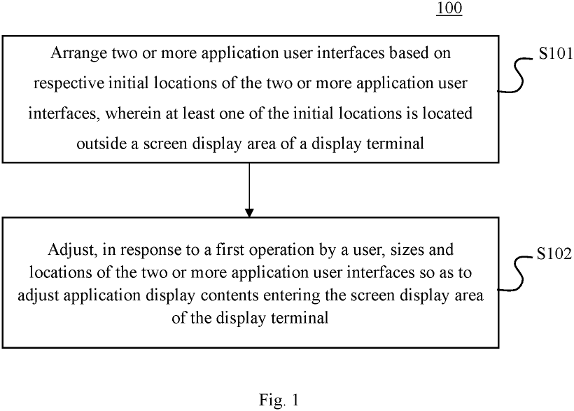

Referring to FIG. 1, FIG. 1 shows a flow diagram of an information display method 100 provided according to an embodiment of the disclosure. The method 100 includes step S101 -step S102.

Step S101: two or more application user interfaces are arranged based on respective initial locations of the two or more application user interfaces, wherein at least one of the initial locations is located outside a screen display area of a display terminal.

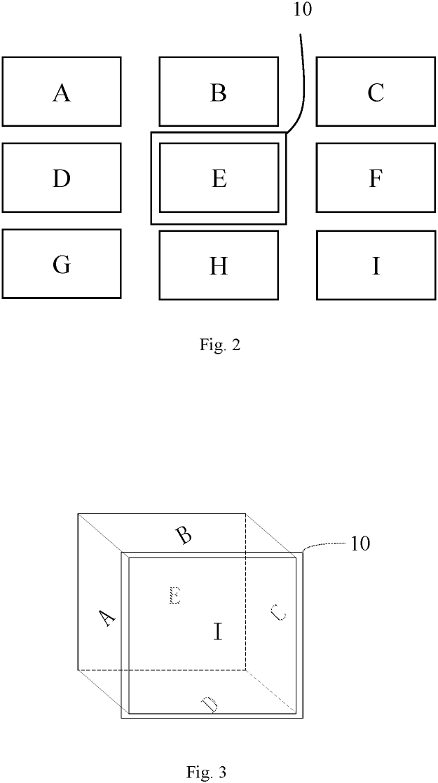

The following FIG. 2 and FIG. 3 are used as examples to describe an initial location of each of predetermined application user interfaces in detail.

FIG. 2 shows a schematic diagram of initial locations of application user interfaces provided according to an embodiment of the disclosure. Referring to FIG. 2, an initial location of an application user interface E is located within a screen display area 10 of a display terminal, initial locations of application user interfaces A, B, C, D, F, G, H, and I are located outside the screen display area of the display terminal. Referring to FIG. 2, the application user interfaces A, B, C, D, F, G, H, and I are arranged on the same plane around the application user interface E.

FIG. 3 shows a schematic layout of application user interfaces provided by another embodiment of the disclosure. Referring to FIG. 3, an initial location of an application user interface I is located within a screen display area 10 of a display terminal, and planes in which application user interfaces A, B, C, D, and E are located and a plane in which the application user interface I is located form the six sides of a rectangle.

It should be noted that, as shown in FIG. 4, “at least one of the initial locations is located outside a screen display area of a display terminal” in step S101 may include the case where a portion of the initial location which is located outside a screen display area of a display terminal may be located within the screen display area.

It should also be noted that step S101 may be executed in response to user instructions or may be predetermined, for example, when the terminal currently displays the application user interface E, the application user interface E and the application user interface A, B, C, D, F, G, H and I are arranged according to this predetermined location relationship.

Step S102: sizes and locations of the two or more application user interfaces are adjusted in response to a first operation by a user, so as to adjust application display contents entering the screen display area of the display terminal.

The application display contents refer to contents of the application user interfaces displayed within the screen display area of the display terminal, including the sizes, the locations or the quantity of the application user interfaces.

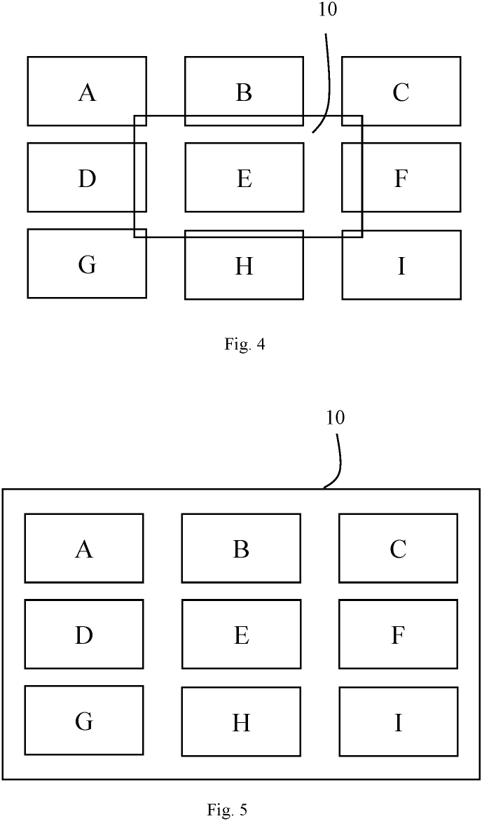

FIG. 5 shows a schematic diagram of arrangement of application user interfaces in response to the first operation provided according to another embodiment of the disclosure. Referring to FIG. 2 and FIG. 5, by adjusting the sizes and locations of the application user interfaces A-I arranged based on the initial locations in response to the first operation according to the embodiment of the disclosure, application display contents from application user interfaces A-I entering the screen display area 10 is adjusted from one larger application user interface E shown in FIG. 2 to nine smaller application user interfaces A-I shown in FIG. 5.

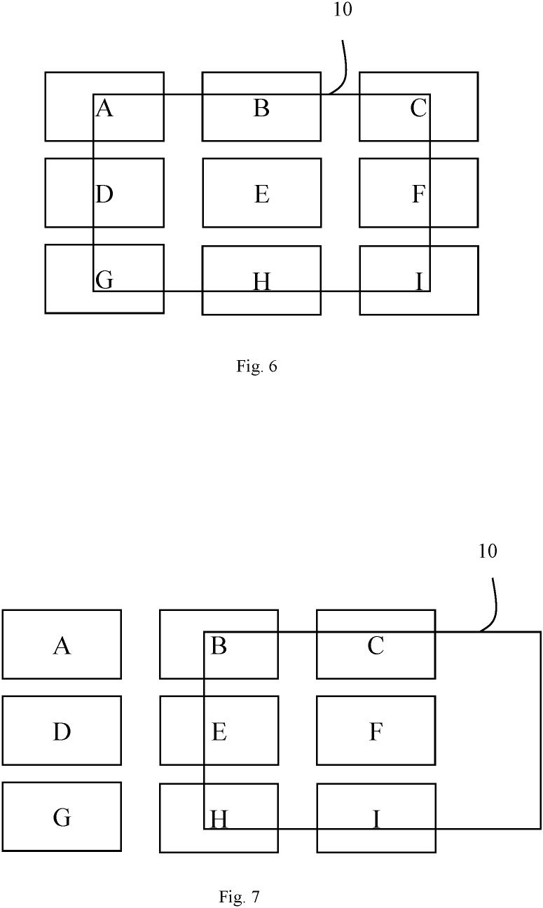

FIG. 6 shows a schematic diagram of arrangement of application user interfaces in response to the first operation provided according to another embodiment of the disclosure. Referring to FIG. 6, an application user interface E is displayed within a screen display area 10 of a display terminal, and parts of each of other application user interfaces A, B, C, D, F, G, H, and I running on the terminal are displayed in the screen display area 10 of the display terminal.

According to the information display method provided by the embodiment of the disclosure, by arranging each application user interface based on the initial locations and adjusting the location of each application user interface in response to the first operation to adjust the application display contents in the screen display area of the display terminal, a user can conveniently and quickly select the application user interface on a screen, such as selecting a target application user interface not originally displayed on the screen, or adjusting sizes and locations of the application user interfaces to facilitate the selection of the target application user interface, thereby improving interaction efficiency and interaction experience.

In some embodiments, step S102 may include:
step A1: a mapping relationship between motion sensor information and a predetermined scaling parameter is obtained;
step A2: the motion sensor information detected by a motion sensor is obtained;
step A3: a scaling parameter is determined based on the obtained motion sensor information and the mapping relationship; and
step A4: the sizes and locations of the two or more application user interfaces are adjusted based on the scaling parameter.

The motion sensor may be an acceleration sensor, a geomagnetic sensor, a gravity sensor, etc., and the motion sensor information includes a speed, accelerated speed, three-axis angle, displacement, and horizontal and vertical coordinate offset converted from the above, etc. The mapping relationship of the motion sensor information and the predetermined scaling parameter may be stored in advance in the terminal or obtained from a server. The mapping relationship involves a relationship between at least one value range of the motion sensor information and at least one predetermined scaling parameter.

Since the motion sensor information is sent in real time in response to changes in the location or motion of a terminal, screen jitter will be generated if the sizes and locations of the application user interfaces are dynamically adjusted directly based on the motion sensor information. Therefore, according to the embodiment of the disclosure, by obtaining the mapping relationship between the motion sensor information and the predetermined scaling parameter and finally adjusting the sizes and locations of the application user interfaces by the predetermined scaling parameter associated with the motion sensor information, screen jitter can be prevented, thereby improving the user experience.

In some embodiments, the method 100 may further include: motion sensor information detected by a motion sensor is obtained, where the motion sensor information includes a speed and/or an accelerated speed; and the two or more application user interfaces are moved based on the motion sensor information, where the greater the speed and/or accelerated speed included in the motion sensor information, the greater the movement displacement of the two or more application. Referring to FIG. 7, in the embodiment of the disclosure, each application user interface moves based on the speed and/or accelerated speed information of the obtained motion sensor information, and the movement speed of the application interface increases with speed, thus allowing the user to select the application interface easily and quickly, and improving the interaction efficiency.

In some embodiments, the motion sensor information may be obtained by receiving a remote control instruction sent by a remote control apparatus based on the motion sensor information detected by a built-in motion sensor, so that the user can remotely control the application display content of the terminal device by manipulating a motion sensor in the remote control apparatus. The user can adjust the sizes and locations of the application user interfaces by controlling a remote control. The remote control instruction is determined by the remote control apparatus based on the motion sensor information detected by the built-in motion sensor.

In some embodiments, in the adjusted application display content, a portion of the application display contents is displayed in the screen display area both before and after the adjusting. Exemplarily, referring to FIG. 2 and FIG. 5, the application display content in the screen display area 10 is adjusted from one larger application user interface E shown in FIG. 2 to nine smaller application user interfaces A-I shown in FIG. 5, where although the size and location of the application user interface E is changed after adjusting, it is displayed in the screen display area 10 before and after adjusting. In this way, in the embodiment, since there is a common part of application display contents both before and after adjustment, it can be convenient for the user to quickly locate and select the application interface even after the application information in the visible display area is adjusted, thus improving the interaction efficiency and interaction experience.

In some embodiments, step S102 may include:
step B1: when the sizes of the two or more application user interfaces increase, an application user interface located outside the center of the screen display area moves away from the center of the screen display area; and/or
step B2: when the sizes of the two or more application user interfaces decrease, an application user interface located outside the center of the screen display area moves towards the center of the screen display area.

In some embodiments, when the sizes of the two or more application user interfaces increase, an application user interface located outside a predetermined central region of the screen display area moves away from the predetermined central region; and/or when the sizes of the two or more application user interfaces decrease, an application user interface located outside a predetermined central region of the screen display area moves towards the predetermined central region, where can be the predetermined central region can be the center of the screen display area.

In this way, according to the information display method provided by the embodiment, whether each application user interface is reduced or enlarged in response to the first operation, the relative location of each application user interface will not change, and the sizes and locations of the application user interfaces will be adjusted by the same magnitude, so that the application display content in the screen display area is adjusted without disrupting the layout of each application user interface, thereby facilitating the user to select the application user interface and improving the interaction efficiency and interaction experience.

In some embodiments, the two or more application user interfaces are embedded within the same window interface, where the sizes and locations of the two or more application user interfaces change along with a size of the window interface; and step S102 may include:

the size of the window interface is adjusted based on the first operation to adjust the application display contents entering the screen display area of the display terminal.

In some embodiments, the window interface may be a Window of an Android platform, which is an abstract class that may be configured to host application user interfaces, where the size and location of each application user interface hosted in the Window may change along with the size of the Window. These embodiments can realize the simultaneous adjustment of the size and location of each application user interface by adjusting the size of the window interface (i.e., scaling the whole layout), so that the application display content in the screen display area is adjusted without disrupting the layout of each application user interface, thereby facilitating the user to select the application user interface and improving the interaction efficiency and interaction experience.

In some embodiments, step S102 may include:

step C1: a target boundary coordinate of the screen display area is determined based on a current boundary coordinate of the screen display area and the first operation; and step C2: the sizes and locations of the two or more application user interfaces are adjusted based on the target boundary coordinate and boundary coordinates of the respective initial locations of the two or more application user interfaces.

Exemplarily, referring to FIG. 2, if the current boundary coordinate of the screen display area 10 of the display terminal is (-600, 600, 600, -600), the boundary coordinate of the initial location of the application user interface E is (-400, 400, 400, -400), and the first operation is to reduce the sizes of the application user interfaces A-I (i.e., the application user interface A to the application user interface I), such as reduce the sizes of the application user interface A-I to be one half of an original size, the target boundary coordinate of the screen display area may be determined as (-1200, 1200, 1200, -1200), so that the size and location of this application user interface can be adjusted based on the target boundary coordinate as (-1200, 1200, 1200, -1200) and the boundary coordinate of the initial location of the application user interface E as (-400, 400, 400, -400). For example, the boundary coordinate of the screen display area may be refreshed directly to the target boundary coordinate (-1200, 1200, 1200, -1200), while the boundary coordinate of the application user interface E within the new boundary coordinate of the screen display area 10 remain unchanged. Referring to FIG. 5, the application user interface E is redisplayed within the screen display area 10 according to the original coordinate (-400, 400, 400, -400) of the application user interface E. It should be noted that adjusting the boundary coordinate of the screen display area only changes the scale of a coordinate system, but the actual size of the screen display area does not change, i.e., a larger boundary coordinate of the screen display area does not mean that the actual size of the screen display area becomes larger. Thus, referring to FIG. 5, the size of the application user interface E is then reduced to be one half of the original size, and the sizes and locations of the application user interfaces A-I are adjusted adaptively in a similar way.

In some embodiments, step C1 includes: the target boundary coordinate of the screen display area is determined based on a scaling parameter associated with the first operation and an original boundary coordinate of the screen display area; and step C2 includes: the adjusted sizes and locations of the two or more application user interfaces displayed within the screen display area are determined, while keeping the display size of the screen display area unchanged, based on a relative relation between the boundary coordinates of the respective initial locations of the two or more application user interfaces and the target boundary coordinate of the screen display area.

In this way, in the embodiment of the disclosure, the adjusted sizes and locations of the application user interfaces can be easily determined based on the target boundary coordinate of the screen display area and the boundary coordinates of the initial locations of the application user interfaces, which consumes less computational resources and ensures the consistent adjustment of the sizes and locations of the application user interfaces, so that the application display content in the screen display area is adjusted without disrupting the layout of each application user interface, thereby facilitating the user to select the application user interface and improving the interaction efficiency and interaction experience.

It should be noted that the target boundary coordinate in the embodiment may be a reference quantity configured to assist in calculating the adjusted sizes and locations of the application user interface without actually changing the boundary coordinate of the screen display area to the target boundary coordinate, but rather the adjusted sizes and locations of the application user interfaces may be determined according to the relative relationship between the target boundary coordinate and the boundary coordinates of the respective initial locations of the application user interfaces.

In some embodiments, the two or more application user interfaces include windows of foreground applications and/or background applications of the display terminal. In the related art in this field, usually only windows of one or more foreground applications are displayed in the screen display area of the display terminal, windows of background applications are not displayed in the screen display area, and the user usually needs to open an application management list before calling out the windows of the background applications, and the windows of the background applications are opened and displayed by selecting screenshots corresponding to the windows of the background applications. In the embodiment of the disclosure, the windows of the foreground application and/or background application of the display terminal are laid out based on the initial position, where at least one of the foreground and/or background application windows is located outside the screen display area of the display terminal, and on this basis, the application display content in the screen display area can be adjusted by adjusting the size and location of each application window, for example, all or part of the contents of multiple application windows whose initial position is outside the screen display area can be displayed within the screen display area by the first operation, so that the user can easily and quickly select the application windows that are not originally displayed on the screen and improve the interaction efficiency.

In some embodiments, step S102 may include: a spacing between the two or more application user interfaces is adjusted based on the first operation. In the embodiment of the disclosure, by synchronously reducing the application user interfaces and the spacing between the application user interfaces, the neatness of the arrangement between the application user interfaces can be maintained, especially when the spacing of each interface is reduced simultaneously with the reduction of each interface, more application user interfaces may be displayed within the screen display area, so that more application user interfaces can be selected by the user conveniently and quickly, and the interaction efficiency can be improved.

In some embodiments, the initial locations of the two or more application user interfaces are arranged based on last active time associated with each application. In the embodiment of the disclosure, each application is associated with the last active time, and each application user interface is arranged based on its own last active time. For example, the application user interface with the later last active time is closer to the center of the screen display area of the display terminal. According to the embodiment of the disclosure, by setting the predetermined location relation based on the last active time of each application, the user can conveniently and quickly find the application user interface they wish to select, thereby improving the interaction efficiency. In some embodiment, the user last operation time is the last moment when the user browses the application user interface, for example, if the user exits the application A at a moment a, a system can record that moment a, and the moment a is the last active time of the application A before the user reopens the application A next time.

In some embodiments, step S102 may include:
step D1: an image captured by a camera apparatus are received;
step D2: a user gesture command is obtained based on the image; and
step D3: the sizes and locations of the two or more application user interfaces are adjusted based on the user gesture command. Thus, the user can adjust the size and location of each application user interface through gestures, thereby improving the interaction efficiency, for example, zooming and synchronized movement of each application screen can be controlled by flexing and extending five fingers.

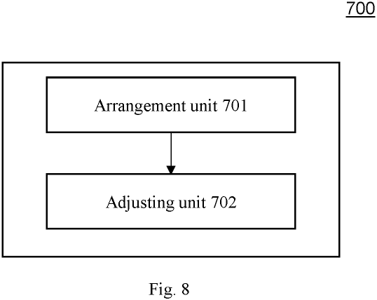

For the above information display method, FIG. 8 shows a schematic structural diagram of an information display device 700 provided according to an embodiment of the disclosure, and the device 700 includes:
an arrangement unit 701, configured to arrange two or more application user interfaces based on respective initial locations of the two or more application user interfaces, where at least one of the initial locations is located outside a screen display area of a display terminal; and
an adjusting unit 702, configured to adjust sizes and locations of the two or more application user interfaces in response to a first operation, so as to adjust application display contents entering the screen display area of the display terminal.

According to the information display device provided by the embodiment of the disclosure, by arranging each application user interface based on the initial locations and adjusting the location of each application user interface in response to the first operation to adjust the application display contents in the screen display area of the display terminal, a user can conveniently and quickly select the application user interface on a screen, such as selecting a target application user interface not originally displayed on the screen, or adjusting sizes and locations of the application user interfaces to facilitate the selection of the target application user interface, thereby improving interaction efficiency and interaction experience.

For the embodiment of the device, which basically corresponds to the method embodiment, it is sufficient to refer to the description of the method embodiment for the relevant parts. The embodiments of the device described above are merely schematic, where the modules illustrated as separate modules may or may not be separate. Some or all of these modules may be selected according to practical needs to achieve the purpose of this embodiment solution. It can be understood and implemented without creative work by a person of ordinary skill in the art.

In some embodiments, the adjusting unit 702 further includes:
a mapping acquisition subunit, configured to obtain a mapping relationship between motion sensor information and a predetermined scaling parameter;
a sensor information subunit, configured to obtain the motion sensor information detected by a motion sensor;
a scaling parameter subunit, configured to determine a scaling parameter based on the obtained motion sensor information and the mapping relationship; and
a first adjustment subunit, configured to adjust the sizes and locations of the two or more application user interfaces based on the scaling parameter.

The motion sensor may be an acceleration sensor, a geomagnetic sensor, a gravity sensor, etc., and the motion sensor information includes a speed, accelerated speed, three-axis angle, displacement, and horizontal and vertical coordinate offset converted from the above, etc. The mapping relationship of the motion sensor information and the predetermined scaling parameter may be stored in advance in the terminal or obtained from a server.

Since the motion sensor information is sent in real time in response to changes in the location or motion of a terminal, screen jitter will be generated if the sizes and locations of the application user interfaces are dynamically adjusted directly based on the motion sensor information. Therefore, according to the embodiment of the disclosure, by obtaining the mapping relationship between the motion sensor information and the predetermined scaling parameter and finally adjusting the sizes and locations of the application user interfaces by the predetermined scaling parameter associated with the motion sensor information, screen jitter can be prevented, thereby improving the user experience.

In some embodiments, the device 700 further includes:
a sensor subunit, configured to obtain motion sensor information detected by a motion sensor where the motion sensor information includes a speed and/or an accelerated speed; and
a movement subunit, configured to move the two or more application user interfaces based on the motion sensor information, where the greater the speed and/or accelerated speed included in the motion sensor information, the greater the movement displacement of the two or more application.

Referring to FIG. 7, in the embodiment of the disclosure, each application user interface moves based on the speed and/or accelerated speed information of the obtained motion sensor information, and the movement speed of the application interface increases with speed, thus allowing the user to select the application interface easily and quickly, and improving the interaction efficiency.

In some embodiments, the device 700 further includes:

a receiving subunit, configured to receive a remote control instruction sent by a remote control apparatus, the remote control instruction being determined by the remote control apparatus based on the motion sensor information detected by a built-in motion sensor. Therefore, the user can remotely control the application display content of the terminal device by manipulating a motion sensor in the remote control apparatus. The user can adjust the sizes and locations of the application user interfaces by controlling a remote control. The remote control instruction is determined by the remote control apparatus based on the motion sensor information detected by the built-in motion sensor.

In some embodiments, in the adjusted application display content, a portion of the application display contents is displayed in the screen display area both before and after the adjusting. Exemplarily, referring to FIG. 2 and FIG. 5, the application display content in the screen display area 10 is adjusted from one larger application user interface E shown in FIG. 2 to nine smaller application user interfaces A-I shown in FIG. 5, where although the size and location of the application user interface E is changed after adjusting, it is displayed in the screen display area 10 before and after adjusting. In this way, in the embodiment, since there is a common part of application display contents both before and after adjustment, it can be convenient for the user to quickly locate and select the application interface even after the application information in the visible display area is adjusted, thus improving the interaction efficiency and interaction experience

In some embodiments, when the sizes of the two or more application user interfaces increase, an application user interface located outside the center of the screen display area moves away from the center of the screen display area; and/or when the sizes of the two or more application user interfaces decrease, an application user interface located outside the center of the screen display area moves towards the center of the screen display area.

In this way, according to the information display device provided by the embodiment, whether each application user interface is reduced or enlarged in response to the first operation, the relative location of each application user interface will not change, and the sizes and locations of the application user interfaces will be adjusted by the same magnitude, so that the application display content in the screen display area is adjusted without disrupting the layout of each application user interface, thereby facilitating the user to select the application user interface and improving the interaction efficiency and interaction experience.

In some embodiments, the two or more application user interfaces are embedded within the same window interface, where the sizes and locations of the two or more application user interfaces change along with a size of the window interface; and the adjusting unit 702 includes:

a window adjustment unit, configured adjust the size of the window interface based on the first operation to adjust the application display contents entering the screen display area of the display terminal.

In some embodiments, the window interface may be a Window of an Android platform, which is an abstract class that may be configured to host application user interfaces, where the size and location of each application user interface hosted in the Window may change along with the size of the Window. These embodiments can realize the simultaneous adjustment of the size and location of each application user interface by adjusting the size of the window interface (i.e., scaling the whole layout), so that the application display content in the screen display area is adjusted without disrupting the layout of each application user interface, thereby facilitating the user to select the application user interface and improving the interaction efficiency and interaction experience.

In some embodiments, the adjusting unit 702 includes:
a target coordinate determining unit, configured to determine a target boundary coordinate of the screen display area based on a current boundary coordinate of the screen display area and the first operation; and
a second adjustment unit configured to adjust the sizes and locations of the two or more application user interface based on the target boundary coordinate and boundary coordinates of the respective initial locations of the two or more application user interfaces.

Exemplarily, referring to FIG. 2, if the current boundary coordinate of the screen display area 10 of the display terminal is (-600, 600, 600, -600), the boundary coordinate of the initial location of the application user interface E is (-400, 400, 400, -400), and the first operation is to reduce the sizes of the application user interfaces A-I (i.e., the application user interface A to the application user interface I), such as reduce the sizes of the application user interface A-I to be one half of an original size, the target boundary coordinate of the screen display area may be determined as (-1200, 1200, 1200, -1200), so that the size and location of this application user interface can be adjusted based on the target boundary coordinate as (-1200, 1200, 1200, -1200) and the boundary coordinate of the initial location of the application user interface E as (-400, 400, 400, -400). For example, the boundary coordinate of the screen display area may be refreshed directly to the target boundary coordinate (-1200, 1200, 1200, -1200), while the boundary coordinate of the application user interface E within the new boundary coordinate of the screen display area 10 remain unchanged. Referring to FIG. 5, the application user interface E is redisplayed within the screen display area 10 according to the original coordinate (-400, 400, 400, -400) of the application user interface E. It should be noted that adjusting the boundary coordinate of the screen display area only changes the scale of a coordinate system, but the actual size of the screen display area does not change, i.e., a larger boundary coordinate of the screen display area does not mean that the actual size of the screen display area becomes larger. Thus, referring to FIG. 5, the size of the application user interface E is then reduced to be one half of the original size, and the sizes and locations of the application user interfaces A-I are adjusted adaptively in a similar way.

In this way, in the embodiment of the disclosure, the adjusted sizes and locations of the application user interfaces can be easily determined based on the target boundary coordinate of the screen display area and the boundary coordinates of the initial locations of the application user interfaces, which consumes less computational resources and ensures the consistent adjustment of the sizes and locations of the application user interfaces, so that the application display content in the screen display area is adjusted without disrupting the layout of each application user interface, thereby facilitating the user to select the application user interface and improving the interaction efficiency and interaction experience.

It should be noted that the target boundary coordinate in the embodiment may be a reference quantity configured to assist in calculating the adjusted sizes and locations of the application user interface without actually changing the boundary coordinate of the screen display area to the target boundary coordinate, but rather the sizes and locations of the application user interfaces may be adjusted based on the relative relationship between the target boundary coordinate and the boundary coordinates of the respective initial locations of the application user interfaces.

In some embodiments, the two or more application user interfaces include windows of foreground applications and/or background applications of the display terminal. In the related art in this field, usually only windows of one or more foreground applications are displayed in the screen display area of the display terminal, windows of background applications are not displayed in the screen display area, and the user usually needs to open an application management list before calling out the windows of the background applications, and the windows of the background applications are opened and displayed by selecting screenshots corresponding to the windows of the background applications. In the embodiment of the disclosure, the windows of the foreground application and/or background application of the display terminal are laid out based on the initial position, where at least one of the foreground and/or background application windows is located outside the screen display area of the display terminal, and on this basis, the application display content in the screen display area can be adjusted by adjusting the size and location of each application window, for example, all or part of the contents of multiple application windows whose initial position is outside the screen display area can be displayed within the screen display area by the first operation, so that the user can easily and quickly select the application windows that are not originally displayed on the screen and improve the interaction efficiency.

In some embodiments, the adjusting unit 702 is configured to adjust a spacing between the two or more application user interfaces based on the first operation. In the embodiment of the disclosure, by synchronously reducing the application user interfaces and the spacing between the application user interfaces, the neatness of the arrangement between the application user interfaces can be maintained, especially when the spacing of each interface is reduced simultaneously with the reduction of each interface, more application user interfaces may be displayed within the screen display area, so that more application user interfaces can be selected by the user conveniently and quickly, and the interaction efficiency can be improved.

In some embodiments, the initial locations of the two or more application user interfaces are arranged based on last active time associated with each application. In the embodiment of the disclosure, each application is associated with the last active time, and each application user interface is arranged based on its own last active time. For example, the application user interface with the later last active time is closer to the center of the screen display area of the display terminal. According to the embodiment of the disclosure, by setting the predetermined location relation based on the last active time of each application, the user can conveniently and quickly find the application user interface they wish to select, thereby improving the interaction efficiency. In some embodiment, the user last operation time is the last moment when the user browses the application user interface, for example, if the user exits the Application A at a moment a, a system can record that moment a, and the moment a is the last active time of the Application A before the user reopens the Application A next time.

In some embodiments, the adjusting unit 702 may include:
an image receiving subunit, configured to receive an image captured by a camera apparatus;
a gesture acquisition subunit, configured to obtain a user gesture command based on the image; and
a third adjustment subunit, configured to adjust the sizes and locations of the two or more application user interfaces based on the user gesture command. Thus, the user can adjust the size and location of each application user interface through gestures, thereby improving the interaction efficiency, for example, zooming and synchronized movement of each application screen can be controlled by flexing and extending five fingers.

Correspondingly, the disclosure further provides a terminal comprising:
at least one processor;
and at least one memory communicatively coupled to the at least one processor and storing instructions that upon execution by the at least one processor cause the terminal to perform the information display method.

Correspondingly, the disclosure further provides a non-transitory computer storage medium storing computer-readable instructions to perform the foregoing information display method when the computer-readable instructions are executed by a computing device.

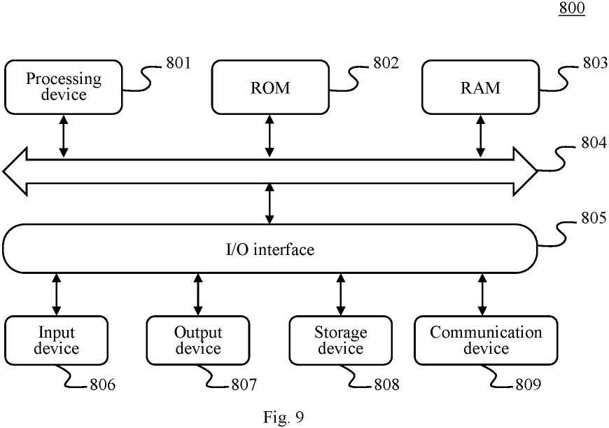

Referring now to FIG. 9, a structural schematic diagram of terminal equipment 800 suitable for implementing an embodiment of the disclosure is shown. The terminal equipment in the embodiment of the present disclosure can include, but is not limited to, mobile terminals such as a mobile phone, a notebook computer, a digital broadcast receiver, a personal digital assistant (PDA), a Pad, a portable media player (PMP) and a vehicle-mounted terminal (e.g., vehicle-mounted navigation terminal), and fixed terminals such as a digital TV and a desktop computer. The terminal equipment shown in FIG. 9 is only an example, and should not bring any restrictions on the functions and application scope of the embodiments of the present disclosure.

As shown in FIG. 9, the terminal equipment 800 can comprise a processing device (e.g., central processing unit, graphics processor, etc.) 801, which can perform various appropriate actions and processing according to a program stored in a read-only memory (ROM) 802 or a program loaded into a random access memory (RAM) 803 from a storage device 808. In the RAM 803, various programs and data required for the operation of the terminal equipment 800 are also stored. The processing device 801, the ROM 802, and the RAM 803 are connected through a bus 804. An Input/Output (I/O) interface 805 is also connected to the bus 804.

Generally, the following devices can be connected to the I/O interface 805: an input device 806 such as a touch screen, a touch pad, a keyboard, a mouse, a camera, a microphone, an accelerometer and a gyroscope; an output device 807 such as a liquid crystal display (LCD), a speaker and a vibrator; a storage device 808 such as a magnetic tape and a hard disk; and a communication device 809. The communication device 809 can allow the terminal equipment 800 to perform wireless or wired communication with other equipment to exchange data. Although FIG. 9 shows the terminal equipment 800 with various devices, it should be understood that it is not required to implement or provide all the devices shown. More or fewer devices may alternatively be implemented or provided.

Particularly, according to the embodiments of the disclosure, the processes described above with reference to the flowcharts may be implemented as computer software programs. For example, the embodiments of the disclosure comprise a computer program product comprising a computer program carried by a computer-readable medium, and the computer program contains program codes for executing the method shown in the flowcharts. In such embodiment, the computer program can be downloaded and installed from a network through the communication device 809, or installed from the storage device 808, or installed from the ROM 802. When the computer program is executed by the processing device 801, the above functions defined in the method of the embodiments of the disclosure are executed.

It should be noted that the above-mentioned computer-readable medium can be a computer-readable signal medium or a computer-readable storage medium or any combination of the two. The computer-readable storage medium may be, for example, but not limited to, an electrical, magnetic, optical, electromagnetic, infrared or semiconductor system, device or component, or any combination of the above. More specific examples of the computer-readable storage medium may include, but are not limited to, an electrical connector with one or more wires, a portable computer disk, a hard disk, an RAM, an ROM, an electrically erasable programmable read only memory (EPROM) or flash memory, an optical fiber, a portable compact disc read-only memory (CD-ROM), an optical storage device, a magnetic storage device, or any suitable combination of the above. In the disclosure, the computer-readable storage medium can be any tangible medium containing or storing a program, which can be used by or in combination with an instruction execution system, device or component. In the disclosure, the computer-readable signal medium can comprise a data signal propagated in a baseband or as part of a carrier wave, in which computer-readable program codes are carried. This propagated data signal can take various forms, including but not limited to an electromagnetic signal, an optical signal or any suitable combination of the above. The computer-readable signal medium can also be any computer-readable medium other than the computer-readable storage medium, and the computer-readable signal medium can send, propagate or transmit the program for use by or in connection with the instruction execution system, device or component. The program codes contained in the computer-readable medium can be transmitted by any suitable medium, including but not limited to electric wire, optical cable, radio frequency (RF) or any suitable combination of the above.

In some embodiments, the client and the server can use any currently known or future developed network protocols such as HTTP (Hyper Text Transfer Protocol) to communicate, and can communicate with any form or medium digital data communications (e.g., communications networks) interconnected. Examples of communication networks include local area networks (“LAN”), wide area networks (“WAN”), the Internet, and peer-to-peer networks (e.g., ad hoc peer-to-peer networks), as well as any currently known or future developed network.

The computer-readable medium can be included in the terminal equipment, and can also exist alone without being assembled into the terminal equipment.

The computer-readable medium stores one or more programs that upon execution by the terminal cause the terminal to: arrange two or more application user interfaces based on respective initial locations of the two or more application user interfaces, wherein at least one of the initial locations is located outside a screen display area of a display terminal; and adjust, in response to a first operation by a user, sizes and locations of the two or more application user interfaces so as to adjust application display contents entering the screen display area of the display terminal.

Or, the computer-readable medium stores one or more programs that upon execution by the terminal cause the terminal to: arrange two or more application user interfaces based on respective initial locations of the two or more application user interfaces, wherein at least one of the initial locations is located outside a screen display area of a display terminal; and adjust, in response to a first operation by a user, sizes and locations of the two or more application user interfaces so as to adjust application display contents entering the screen display area of the display terminal.

Computer program codes for performing the operations of the disclosure can be written in one or more programming languages or a combination thereof, including object-oriented programming languages such as Java, Smalltalk, C++, and conventional procedural programming languages such as “C” language or similar programming languages. The program code can be completely or partially executed on a user computer, executed as an independent software package, partially executed on a user computer and partially executed on a remote computer, or completely executed on a remote computer or server. In a case involving a remote computer, the remote computer can be connected to a user computer through any kind of network including a local area network (LAN) or a wide area network (WAN), or can be connected to an external computer (e.g., connected through the Internet using an Internet service provider).

The flowcharts and block diagrams in the drawings show the architectures, functions and operations of possible implementations of systems, methods and computer program products according to various embodiments of the disclosure. In this regard, each block in the flowchart or block diagram can represent a module, a program segment or part of a code that contains one or more executable instructions for implementing a specified logical function. It should also be noted that in some alternative implementations, the functions noted in the blocks can also occur in a different order from those noted in the drawings. For example, two consecutive blocks can actually be executed in substantially parallel, and sometimes they can be executed in reverse order, depending on the functions involved. It should also be noted that each block in the block diagrams and/or flowcharts, and combinations of blocks in the block diagrams and/or flowcharts, can be implemented with dedicated hardware-based systems that perform specified functions or actions, or can be implemented with combinations of dedicated hardware and computer instructions.

The modules or units described in the embodiments of the disclosure can be implemented by software or hardware. The name of a module or unit does not constitute a limitation to the module or unit itself under certain circumstances. For example, the arrangement unit can also be described as “a unit for arranging two or more application user interfaces based on respective initial locations of the two or more application user interfaces”.

The functions described herein above may be performed, at least in part, by one or more hardware logic components. For example, exemplary types of hardware logic components that may be used include: Field Programmable Gate Arrays (FPGAs), Application Specific Integrated Circuits (ASICs), Application Specific Standard Products (ASSPs), Systems on Chips (SOCs), Complex Programmable Logical Devices (CPLDs) and etc.

In the context of the present disclosure, a machine-readable medium may be a tangible medium that may contain or store programs for use by or in combination with an instruction execution system, device, or device. The machine-readable medium may be a machine-readable signal medium or a machine-readable storage medium. Machine readable media may include, but are not limited to, electronic, magnetic, optical, electromagnetic, infrared, or semiconductor systems, devices or devices, or any suitable combination of the above. More specific examples of machine-readable storage media will include electrical connections based on one or more lines, portable computer disks, hard disks, random access memory (RAM), read only memory (ROM), erasable programmable read only memory (EPROM or flash memory), optical fibers, portable compact disk read only memory (CD-ROM), optical storage devices, magnetic storage devices or any suitable combination of the above.

In some embodiments, the disclosure provides an information display method, comprising: arranging two or more application user interfaces based on respective initial locations of the two or more application user interfaces, wherein at least one of the initial locations is located outside a screen display area of a display terminal; and adjusting, in response to a first operation by a user, sizes and locations of the two or more application user interfaces so as to adjust application display contents entering the screen display area of the display terminal.

In some embodiments, the adjusting, in response to a first operation by a user, sizes and locations of the two or more application user interfaces so as to adjust application display contents entering the screen display area of the display terminal comprises: obtaining a mapping relationship between motion sensor information and a predetermined scaling parameter; obtaining the motion sensor information detected by a motion sensor; determining a scaling parameter based on the obtained motion sensor information and the mapping relationship; and adjusting the sizes and locations of the two or more application user interfaces based on the scaling parameter.

In some embodiments, the method further comprises obtaining motion sensor information detected by a motion sensor, wherein the motion sensor information comprises a speed and/or an accelerated speed; and

moving the two or more application user interfaces based on the motion sensor information, wherein the greater the speed and/or accelerated speed included in the motion sensor information, the greater the movement displacement of the two or more application.

In some embodiments, the obtaining motion sensor information detected by a motion sensor comprises: receiving a remote control instruction sent by a remote control apparatus, the remote control instruction being determined by the remote control apparatus based on the motion sensor information detected by a built-in motion sensor.

In some embodiments, when the sizes of the two or more application user interfaces increase, an application user interface located outside a predetermined central region of the screen display area moves away from the predetermined central region; and/or when the sizes of the two or more application user interfaces decrease, an application user interface located outside a predetermined central region of the screen display area moves towards the predetermined central region.

In some embodiments, the adjusting, in response to a first operation by a user, sizes and locations of the two or more application user interfaces so as to adjust application display contents entering the screen display area of the display terminal comprises: determining a target boundary coordinate of the screen display area in response to the first operation; and adjusting the sizes and locations of the two or more application user interfaces based on the target boundary coordinate and boundary coordinates of the respective initial locations of the two or more application user interfaces.

In some embodiments, the two or more application user interfaces comprise windows of a foreground application and/or background application of the display terminal.

In some embodiments, the adjusting, in response to a first operation by a user, sizes and locations of the two or more application user interfaces so as to adjust application display contents entering the screen display area of the display terminal comprises: adjusting a spacing between the two or more application user interfaces in response to the first operation.

In some embodiments, the initial locations of the two or more application user interfaces are arranged based on last active time of each application.

In some embodiments, the adjusting, in response to a first operation by a user, sizes and locations of the two or more application user interfaces so as to adjust application display contents entering the screen display area of the display terminal comprises: receiving an image captured by a camera apparatus; determining a user gesture command based on the image; and adjusting the sizes and locations of the two or more application user interfaces based on the user gesture command.

In some embodiments, the disclosure provides an information display an information display device, comprising: an arrangement unit, configured to arrange two or more application user interfaces based on respective initial locations of the two or more application user interfaces, wherein at least one of the initial locations is located outside a screen display area of a display terminal; and an adjusting unit, configured to adjust, in response to a first operation by a user, sizes and locations of the two or more application user interfaces so as to adjust application display contents entering the screen display area of the display terminal.

In some embodiments, the disclosure provides a terminal, comprising:
at least one processor; and
at least one memory communicatively coupled to the at least one processor and storing instructions that upon execution by the at least one processor cause the terminal to perform the foregoing control method.

In some embodiments, the disclosure provides a computer storage medium, storing computer-readable instructions to perform the foregoing method when the computer-readable instructions are executed by a computing device.

The above description is only a preferred embodiment of the disclosure and an explanation of the applied technical principles. Those skilled in the art should understand that the scope of disclosure involved in this disclosure is not limited to the technical solutions formed by the specific combination of the above technical features, and should also cover other technical solutions formed by any combination of the above technical features or their equivalent features without departing from the above disclosed concept. For example, the above-mentioned features and the technical features disclosed in (but not limited to) the disclosure having similar functions are replaced with each other to form a technical solution.

In addition, although the operations are depicted in a specific order, it should not be understood as requiring these operations to be performed in the specific order shown or performed in a sequential order. Under certain circumstances, multitasking and parallel processing may be advantageous. Likewise, although several specific implementation details are included in the above discussion, these should not be construed as limiting the scope of the disclosure. Certain features that are described in the context of separate embodiments may also be implemented in combination in a single embodiment. Conversely, various features that are described in the context of a single embodiment may also be implemented in multiple implementations individually or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are merely exemplary forms of implementing the claims.

1. An information display method, comprising:
arranging two or more application user interfaces based on respective initial locations of the two or more application user interfaces, wherein at least one of the initial locations is located outside a screen display area of a display terminal; and
adjusting, in response to a first operation by a user, sizes and locations of the two or more application user interfaces so as to adjust application display contents entering the screen display area of the display terminal.

2. The information display method of claim 1, wherein the adjusting, in response to a first operation by a user, sizes and locations of the two or more application user interfaces so as to adjust application display contents entering the screen display area of the display terminal comprises:
obtaining a mapping relationship between motion sensor information and a predetermined scaling parameter;
obtaining the motion sensor information detected by a motion sensor;
determining a scaling parameter based on the obtained motion sensor information and the mapping relationship; and
adjusting the sizes and locations of the two or more application user interfaces based on the scaling parameter.

3. The information display method of claim 1, further comprising:
obtaining motion sensor information detected by a motion sensor, wherein the motion sensor information comprises a speed and/or an accelerated speed; and
moving the two or more application user interfaces based on the motion sensor information, wherein the greater the speed and/or accelerated speed included in the motion sensor information, the greater the movement displacement of the two or more application.

4. The information display method of claim 2 , wherein the obtaining motion sensor information detected by a motion sensor comprises:
receiving a remote control instruction sent by a remote control apparatus, the remote control instruction being determined by the remote control apparatus based on the motion sensor information detected by a built-in motion sensor.

5. The information display method of claim 1, wherein a portion of the application display contents is displayed in the screen display area both before and after the adjusting.

6. The information display method of claim 5, wherein the adjusting, in response to a first operation by a user, sizes and locations of the two or more application user interfaces so as to adjust application display contents entering the screen display area of the display terminal comprises:
when the sizes of the two or more application user interfaces increase, an application user interface located outside a predetermined region of the screen display area moves away from the predetermined region; and/or
when the sizes of the two or more application user interfaces decrease, an application user interface located outside a predetermined region of the screen display area moves towards the predetermined region.

7. The information display method of claim 1,
wherein the two or more application user interfaces are embedded within the same window interface, wherein the sizes and locations of the two or more application user interfaces change along with a size of the window interface; and
wherein the adjusting, in response to a first operation by a user, sizes and locations of the two or more application user interfaces so as to adjust application display contents entering the screen display area of the display terminal comprises: adjusting the size of the window interface in response to the first operation, so as to adjust the application display contents entering the screen display area of the display terminal.

8. The information display method of claim 1, wherein the adjusting, in response to a first operation by a user, sizes and locations of the two or more application user interfaces so as to adjust application display contents entering the screen display area of the display terminal comprises:
determining a target boundary coordinate of the screen display area in response to the first operation; and
adjusting the sizes and locations of the two or more application user interfaces based on the target boundary coordinate and boundary coordinates of the respective initial locations of the two or more application user interfaces.

9. The information display method of claim 8, wherein
the determining a target boundary coordinate of the screen display area in response to the first operation comprises: determining the target boundary coordinate of the screen display area based on a scaling parameter associated with the first operation and an original boundary coordinate of the screen display area; and
the adjusting the sizes and locations of the two or more application user interfaces based on the target boundary coordinate and boundary coordinates of the respective initial locations of the two or more application user interfaces comprises: determining, while keeping the display size of the screen display area unchanged, the adjusted sizes and locations of the two or more application user interfaces displayed within the screen display area based on a relative relation between the boundary coordinates of the respective initial locations of the two or more application user interfaces and the target boundary coordinate of the screen display area.

10. The information display method of claim 1, wherein the two or more application user interfaces comprise windows of a foreground application and/or background application of the display terminal.

11. The information display method of claim 1, wherein the adjusting, in response to a first operation by a user, sizes and locations of the two or more application user interfaces so as to adjust application display contents entering the screen display area of the display terminal comprises:
adjusting a spacing between the two or more application user interfaces in response to the first operation.

12. The information display method of claim 1, wherein the initial locations of the two or more application user interfaces are arranged based on last active time of each application.

13. The information display method of claim 1, wherein the adjusting, in response to a first operation by a user, sizes and locations of the two or more application user interfaces so as to adjust application display contents entering the screen display area of the display terminal comprises:
receiving an image captured by a camera apparatus;
determining a user gesture command based on the image; and
adjusting the sizes and locations of the two or more application user interfaces based on the user gesture command.

14. An information display device, comprising:
at least one processor; and
at least one memory communicatively coupled to the at least one processor and storing instructions that upon execution by the at least one processor cause the device to:
arrange two or more application user interfaces based on respective initial locations of the two or more application user interfaces, wherein at least one of the initial locations is located outside a screen display area of a display terminal; and
adjust, in response to a first operation by a user, sizes and locations of the two or more application user interfaces so as to adjust application display contents entering the screen display area of the display terminal.

15. (canceled)

16. A non-transitory computer-readable storage medium, storing program codes that upon execution by a computing device, cause the computing device to :
arrange two or more application user interfaces based on respective initial locations of the two or more application user interfaces, wherein at least one of the initial locations is located outside a screen display area of a display terminal; and
adjust, in response to a first operation by a user, sizes and locations of the two or more application user interfaces so as to adjust application display contents entering the screen display area of the display terminal.

17. The information display method of claim 6, wherein the predetermined region of the screen display area comprises a central region of the screen display area.
